(19) United States
(12) Patent Application Publication
(10) Pub. No.: US 2003/0034957 A1
(43) Pub. Date: Feb. 20, 2003

(54) Method and system for displaying information related to a television program on a remote control device

(76) Inventors: Thomas James Dubil, Morgan Hill, CA (US); Stuart Peter Mckechnie, San Jose, CA (US)

Correspondence Address: Michael E. Marion, PHILLIPS ELECTRONICS NORTH AMERICA CORPORATION, Corporate Intellectual Property, 580 White Plains Road, Tarrytown, NY, 10591, US

(21) Appl. No.: 09/932,104

(22) Filed: Aug. 17, 2001

(51) Int. Cl. G09G 5/08

(52) U.S. Cl. 345/158

(57) ABSTRACT

A remote control device is provided having a display for enabling a user to view information relating to a television program currently being viewed (or not being viewed) without having the information appearing on the television screen The remote control device of the present disclosure includes the display, e.g., a graphical user interface, for displaying the information relating to the television program, as well as other information The remote control device can receive the information related to the television program currently being viewed by various means, such as an RF link or a direct connection to an Internet connected host, such as a set top box or a personal computer, an RF link to a remote central station which broadcasts an RF modulated signal which includes the information to be displayed, a set top box having a telephone connection for uploading the information to be displayed from the Public Switched Telephone Network (PSTN) or the Internet and transmitting the uploaded information via an RF link to the remote control device, and via an RF link to a set top box receiving a broadcast signal having the information to be displayed therein.

### BACKGROUND OF THE INVENTION

1. Technical Field

The present disclosure relates generally to a remote control device having a display for displaying information related to a television program currently being viewed, as well as other information, such as traffic, weather and news, including interactive information, such as a questionnaire.

2. Background of the Related Art

A well known example of a remote control device is the hand held remote controller for control of consumer audio and video equipment. The controller communicates control signals according to the particular user-input activated device. The majority of modem wireless remote control devices use an infra-red (IR) pulse command code modulated caner to send the control signals.

One of the most widely used remote control devices is a remote control device for controlling a television. A user typically uses such a remote control device to flip through the various channels to locate a desirable program to watch or to determine what other programs are currently being aired as the desirable program or are scheduled to air.

Occasionally, while viewing a television program, a message is broadcasted on a portion of the television screen displaying information related to the television program currently being viewed, or other information, such as traffic reports, weather, and news. For example, during the broadcast of a science program on whales, a message may be broadcast across the bottom portion of the television screen stating, “For additional information on whales, please visit the web site www.save_the_whales.com or call 1-800-555-SAVE.” Another example is that during the broadcast of a court case television program, a message may be broadcast on the bottom right-hand portion of the television screen indicating the percentage of viewers logging in to a web site affiliated with the television program who have stated that they believe the defendant is guilty. This type of message is updated continuously during the airing of the court case television program.

Messages displayed on he television screen can be disruptive to the viewer, especially if he viewer is taping the program being viewed and a certain portion of the program is blocked by the broadcast message. Further, the viewer may be disinterested in the information and is still “forced” to see the message. The viewer may not desire to be a “captive audience member” of the message. However, another viewer watching the program via the same television screen as the viewer may be interested in viewing the message.

A need therefore exists for a remote control device having a display for displaying information related to the television program currently being viewed, as well as other information, such as traffic, weather and news, including interactive information, such as a questionnaire.

### SUMMARY OF THE INVENTION

The present disclosure provides a remote control device having a display for enabling a user to view information relating to a television program currently being viewed (or not being viewed) without having the information appearing on the television screen. The remote control device of the present disclosure includes the display, e.g., a graphical user interface, for displaying the information relating to the television program, as well as other information, such as traffic, weather and news, including interactive information, such as a web site listing or a questionnaire. Preferably, the display is a touch screen for enabling the user to select responses posed by the questionnaire by touching the desired response appearing on the display or situating a cursor over the desired response and performing an action, such as clicking a “SELECT” button. The remote control device also includes a conventional user-interface with multiple user inputs for selective control of a particular one of the functionalities of the television through sending a particular one of multiple control signals to the television.

The remote control device can receive the information to be displayed on the display by various means, such as an 1) RF link or a direct connection to an Internet connected host, such as a set top box or a personal computer, 2) an RF link to a remote central station which broadcasts an RF modulated signal which includes the information to be displayed, 3) a set top box having a telephone connection for uploading the information to be displayed from the Public Switched Telephone Network (PSTN) or the Internet and transmitting the uploaded information via an RF link to the remote control device, and via an RF link to a set top box receiving a broadcast signal having the information to be displayed therein. The information to be displayed may also be received by the remote control device in the form of XML a structured manner of presenting data with XSL to simulate HTML.

### BRIEF DESCRIPTION OF THE DRAWINGS

The invention is further explained by way of example and with reference to the accompanying drawings, wherein:

FIG. 1 is a perspective view of a remote control device having a display for displaying information related to a television program being viewed by a user according to the present invention; and

FIG. 2 is a system showing transmittal of an RF modulated signal, which contains the information to be displayed, to the remote control device of FIG. 1.

### DETAILED DESCRIPTION OF PREFERRED EMBODIMENTS

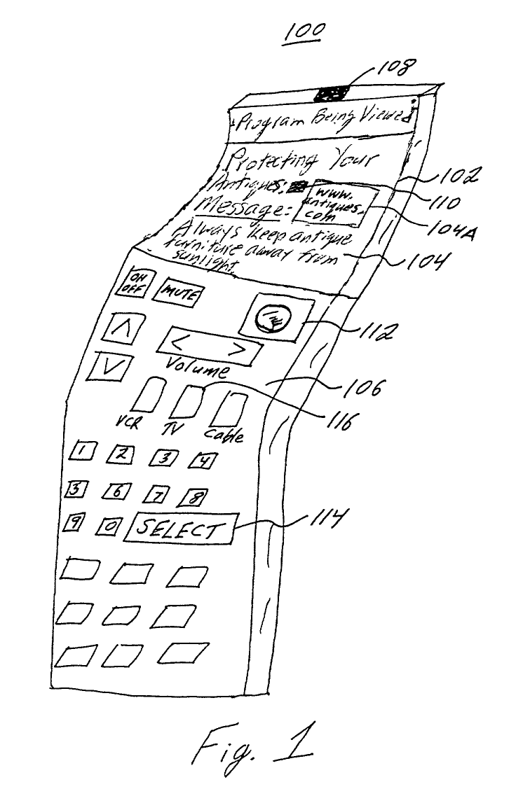

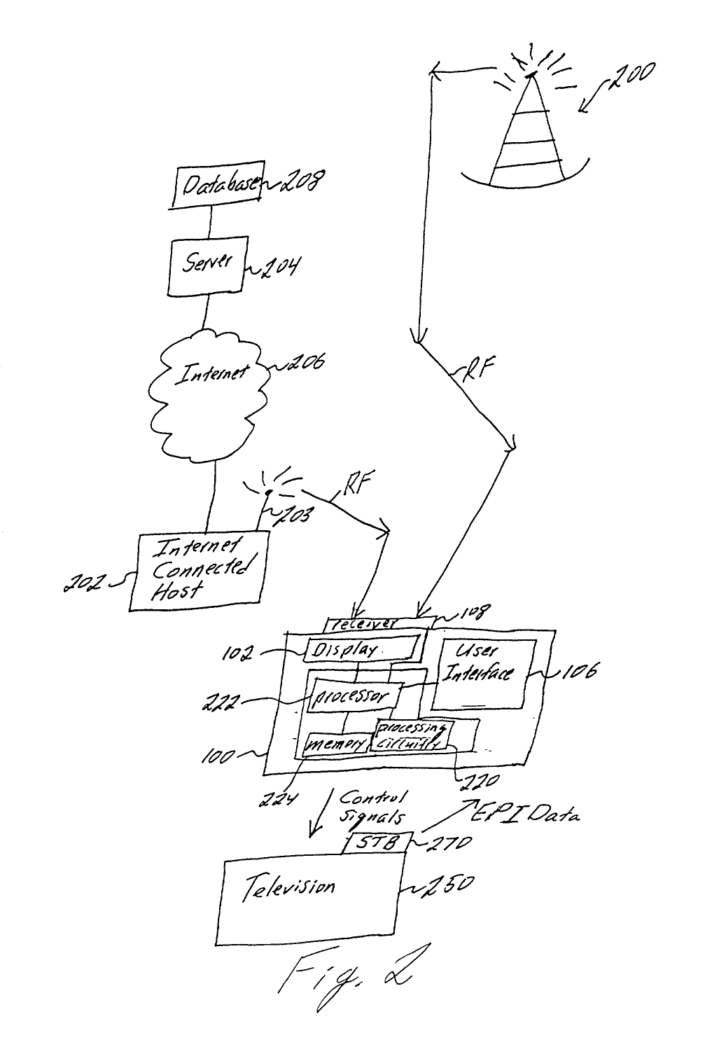

FIG. 1 is a perspective view of a remote control device designated generally by reference numeral 100 which includes a display 102 for display information 104 related to a television program currently being viewed, as well as other information, such as traffic, weather and news, including interactive information, such as a questionnaire, according to an embodiment of the present invention. The remote control device 100 is preferably designed as a universal remote control device for controlling a home entertainment system which includes a television. The television 250 (see FIG. 2) bas multiple functionalities that are user-controllable by the remote control device 100, e.g., “TV-on/off”, “channel up/down”, “mute”, “brightness up”, etc.

The remote control device 100 further includes a user-interface 106 with multiple user-inputs (e.g., buttons, or soft keys on a GUI). The multiple user-inputs provide selective control of a particular one of the multiple functionalities of the television or any other apparatus of the home entertainment system by sending a particular one of multiple control signals. The disclosure herein, however, is not limited to a consumer environment.

The remote control device 100 of the embodiment of FIG. 1 further includes an RF receiver and transmitter (transceiver) 108 for receiving an RF modulated signal which includes the information 104 to be displayed from a remote central station 200 or an Internet connected host 202 (see FIG. 2), such as a set top box or a personal computer. The set top box or PC has standard signal processing components to convert a digital signal containing Internet content to an RF modulated signal and to transmit the RF modulated signal to the remote control device 100. It is contemplated that the remote central station continuously or intermittently transmits the RF modulated signal.

Upon being received by the receiver 108 of the remote control device 100, the RF signal is processed using conventional processing circuitry 220 (see FIG. 2, where internal components of the remote control device 100 are depicted) to retrieve the information 104 to be displayed. The information 104 is then displayed on the display 102 of the remote control device 100.

The information 104 to be displayed may also be received by the remote control device 100 in the form of XML. XML is emerging as the universal format for structured documents and data on the World Wide Web. XML makes it relatively straightforward to define new document types, to author and manage documents and to transmit and share the documents across the Internet. XSL is used for defining style sheets, and provides a language for translating XML documents and an XML vocabulary. XSL specifies the formatting of semantics. Information in XML format on the World Wide Web can be transformed in a presentation format such as HTML, WML or SMIL with XSL style sheets. This separation of semantics and presentation makes possible platform customization and user personalization of World Wide Web content. In an XSL transformation, an XSL processor or application reads an XML document and an XSL style sheet. Based on the instructions in the XSL style sheet, the XSL processor or application supplies a new XML, HTML or otherwise formatted document.

An XML application, such as an XSL style sheet, at the receiving end, operates on the data under control of instructions in the style sheet. This application is used, for example, for control of generating the proper IR or RF commands based on the received data and for

The XML data can also contain control codes associated with the content in order to enable user interaction with a remote device, such as the television 250 or a video cassette recorder, for channel navigation, content recording, etc. The XML data may also contain a Java applet, i.e., a script, e.g., JScript, JavaScript, and VBScript, to provide greater flexibility for GUI presentation and device control. In a home networking environment, e.g., UPnP, HAVi, Jini and others, the remote control device 100 can act as a control point for a set top box, television, recording equipment and other network devices. The XML data can also contain data relating to current or future content available through the television 250 or other device.

For example, a set top box based application can compose an XML or HTML page that can be accessed by the remote control device 100. The set top box acts as an HTTP server to present the content information (the information 104 to be displayed) and navigation control to the user via the remote control device 100. The remote control device 100 receives the page automatically or per user request.

The information 104 may be displayed in any particular display format, and not necessarily in the format intended for display on the television screen. It is provided that the information 104 can be stored in a memory 224 (see FIG. 2) of the remote control device 100 for later viewing or interaction therewith, as described below. For example, it is provided that a web site listing related to the television program currently being viewed is stored within the memory 224 and later accessed for viewing on the display 102. It is contemplated that the web site listing is interactive and a user can touch the display 102 above the web site listing, or click the web site listing, to initiate access of the web site. Upon the user initiating access of the web site, a signal is transmitted to a set top box instructing the set top box to access the web site via an Internet connection. Once accessed, the set top box can transmit the web site contents for vising on the television screen or on the display 102.

Preferably, the display 102 is a touch screen or includes directional cursor control for interacting with interactive information 104A, such as the web site listing in the above example, displayed on the remote control device 100 by touching the interactive information 104A on the display 102 or situating a cursor 110 using a roller-ball 12 over the information 104A and performing an action, such as clicking a “SELECT” button 114 on the user-interface 106 of the remote control device 100. Upon touching the touch screen or performing another action to indicate selection of he interactive information 104A, the remote control device 100 formats a signal that is compatible with the set top box and transmits the signal to the set top box for either accessing a web site, as described above, or to transmit responses to a questionnaire, or other information, to a remote station, such as a server connected to the Internet, as described below with reference to FIG. 2.

As mentioned above, if the viewer desires to read the information 104 related to the television program being viewed at a later time, a processor 222 (see FIG. 2) within the remote control device 100 stores information 104 corresponding to the television program within he memory 224. It is contemplated that the memory 224 of the remote control device 100 can concurrently store information related to a plurality of television programs, i.e., not just information related to the television program being viewed by the user. It is further contemplated that the remote control device 100 can be programmed to only store and/or display certain types of information relating to the television program being viewed.

For example, the remote control device 100 can be programmed to only store and/or display interactive information 104A and historical information, such as information relating to previous events. In such a case, after the remote control device 100 is programmed, an algorithm stored within the memory 224 and executed by the processor 222 can be used to determine if the received information to be displayed belongs in the programmed categories. If the information does not belong to the programmed categories, then the processor 222 does not store and/or display the information. If the information does belong to the programmed categories, then the processor 222 stores and/or displays the information.

The remote control device 100 has stored signal codes that can control more than one television using a TV manual select button 116 to switch between two or more televisions. For example, when the TV manual select button 116 is pressed one time, television A can be controlled, and when the TV manual select button 116 is pressed two times, television B can be controlled until the TV manual select button 116 is pressed again. In such a case, when television A is capable of being controlled, the remote control device 100 only stores and/or displays information related to the television program being shown by television A. When television B is capable of being controlled, the remote control device 100 only stores and/or displays information related to the television program being shown by television B.

With reference to FIG. 2, there is shown a system showing transmittal of the RF modulated signal having the information related to the television program currently being viewed to the remote control device 100. The remote control device is capable of controlling the television 250 by transmitting control signals. The RF modulated signal can either be transmitted from the remote central station 200 or the Internet connected host 202 which can be a set top box or a personal computer. The set top box or personal computer are provided with processing circuitry to convert the digital signal to an RF signal and an antenna 203 for transmitting the RF modulated signal to the remote control device 100.

Preferably, the Internet connected host 202 is connected to a remote server 204 via the Internet 206 or other network. The remote server 204 has access to a database 208 which stores the information 104 related to a host of television programs currently being aired. The remote server 204 thus transmits the information 104 via the Internet 206 to the Internet connected host 202. As noted, the Internet connected host 202 includes processing circuitry, as known in the art, for converting the received information 104 from a digital format to the RF modulated signal for transmission to the remote control device 100 via an antenna 203.

The remote server 204 can be accessed by a user through the use of a conventional web browser, The user can type the URL corresponding to the remote server 204 on the web browser and press “ENTER”. The user will then access a web site corresponding to the URL for subscribing to the system, for reconfiguring the format the information 104 is provided, for authorizing the transmission of the information 104 to the Internet connected host 202, etc.

It is contemplated that the remote control device 100 includes an Internet connection capability, i.e., the remote control device 100 includes at least a web browser and a wireless modem for connecting to the Internet. The user can then use a keyboard of the remote control device 100 for typing the URL corresponding to the remote server 204. Accordingly, the user can access the web site corresponding to the URL with the remote control device 100 and subscribe to the system, as well as perform other tasks, without having to use the Internet connected host 202.

It is also contemplated to program the processor 222 of the remote control device 100 with a set of instructions in order for the remote control device 100 to be able to control other consumer electronic appliances and systems, besides the television 250, such as a microwave, stereo system, radio, satellite television system, Internet radio, alarm system, etc. In this regard, it is contemplated for the remote control device 100 to be used to connect to the Internet, as described above, and then to access a particular web site or the same web site described above. The user can then select an electronic appliance and a corresponding model number from the web site which correspond to the electronic appliance the user wants to control.

Upon selecting the electronic appliance and corresponding model number, the user is then presented with a scrolling list of functions on the display 102. These list of functions are preferably stored within the database 208 or another database, along with their corresponding electronic appliance and model number, and are accessed via the remote server 204 or another remote server before they are made available to the user. The user can then select a particular function, e.g., turn stereo system on, to transmit a sign to the electronic appliance in order to control the electronic appliance, as described above with respect to controlling the television 250. The user can then select other sub-functions to further control the electronic appliance, e.g., tune stereo system to a particular AM/FM channel, play a CD, etc.

As further illustrated by FIG. 2, the information 104 can also be received as electronic program information (EPI), which is typically supplied via a set top box 270 and conventionally displayed on a television's screen. Instead of displaying the EPI data on the television's screen, the EPI data is exported from the set top box 270 to the remote control device 100 via a wireless, e.g., as an RF signal, or non-wireless link and displayed on the remote control device's display 102. The EPI data is preferably embedded within a broadcast signal capable of being received by the set top box 270.

An ergonomic manner of presenting the information to the user is described in co-pending U.S. patent application Ser. No. 09/619,426 filed on Jul. 19, 2000 and titled, “Hand-held with Auto-zoom For Graphical Display of Web Page.” This document describes a feature called “auto-zoom”. The auto-zoom feature is relevant to the rendering of any kind of graphical information on a display too small for the total information content, given the display's resolution and size. For example, handheld information processing devices with Internet access (web browsers) and displays, such as PDAs, web pads, and mobile phones using, e.g., the WAP (wireless application protocol) technology, etc., can be provided with browsers for retrieving and navigating web pages from the Internet, but they cannot render a page in its entirety without losing information. Such handheld devices provided with the auto-zoom feature allows the content on the display 102 to be zoomed in and out.

Accordingly, it is contemplated to provide the auto-zoom feature within the remote control device 100 for zooming in and out the EPI data or other data. It is also contemplated for the display 102 to be operative in enabling the user to select via the touch screen a portion of the image when displayed at a first scale. Upon the portion being selected, the remote control device 100 renders the selected portion on the display 102 at a second scale which is larger than the first scale (zoom-in). The portion selected corresponds to a location on the touch screen.

The remote control device 100 receives the EPI data wirelessly as an RF signal via the receiver 108 and preferably converts the EPI data to digital data using the processing circuitry 220. The EPI data is then displayed on the display 102. The EPI data can also be received non-wirelessly as digital data or other format.

It is contemplated that the EPI data is displayed on the display 102 when an “EPI Button” on the user interface 106 is pressed. It is also contemplated to display the EPI data, upon entering a television channel using the remote control device, which corresponds to the television program being aired by the entered television channel. Accordingly, instead of the television switching channels to the entered channel, the EPI data corresponding to the television program being aired by the entered channel is displayed on the remote control device's display 102. It is also contemplated for the receiver 108, which is a transceiver as indicated above, to communicate wirelessly with the set top box 270 or another processing device for receiving the EPI data. Accordingly, the set top box 270 can be instructed by the remote control device 100 to exclude certain types of EPI data, such as traffic reports.

It is her contemplated for the set top box 270 which receives the EPI data to convert the EPI data into a particular format, such XML, HTML, HomeRF, IP, BlueTooth, 802.11, etc., before transmitting the EPI data to the remote control device 100. Further still, it is contemplated for the remote control device 100 to be equipped with a removable media interface, e.g., FlashCard, PCMCIA, etc., for providing wireless communication capabilities to the remote control device 100. For example, to convert the EPI data received from the set top box 270 into a format acceptable to the remote control device 100.

A service provider operates the remote central station 200, the same or a different service provider operates the remote server 204 and database 208, and the same or a different service provider operates the broadcasting facility which transmits the EPI data to the set top box 270. It is contemplated that the service provider bills subscribers at regular intervals for the service of providing the information 104.

Accordingly, with the device 100, a user is able to view information related to a television program currently being viewed, or not being viewed, on a display of the device 100.

It will be understood that various modifications may be made to the embodiments disclosed herein and that the above description should not be construed as limiting, but merely as exemplifications of preferred embodiments. For example, the information 104 may be received by the remote control device 100 via a direct connection to an Internet connected host or a telephone jack connected to the public switched telephone network (PSTN). Further, the remote control device 100 may be designed to operate by using other type of signals besides RF signals, such as infrared signals. Accordingly, those skilled in the art will envision other modifications wit the scope and spirit of the claims appended hereto.

What is claimed is:

1. A remote control device comprising:
a receiver for wirelessly receiving a signal including information related to at least one television program;
processing circuitry for processing the received signal to obtain the information; and
a display for displaying the information.

2. The remote control device according to claim 1, further comprising an input interface for interacting with the information displayed by the display.

3. The remote control device according to claim 2, wherein the input interface for interacting with the displayed information includes a directional cursor control mechanism having a device for controlling the position of a cursor on the display and a selection button for interacting with a portion of the displayed information corresponding to the position of the cursor.

4. The remote control device according to claim 2, wherein the display and input interface for interacting with the information displayed includes a touch screen that displays the information.

5. The remote control device according to claim 1, wherein the signal is received from one of a remote central station, an Internet connected host, and a set top box.

6. The remote control device according to claim 1, wherein the signal includes XML-formatted data.

7. A system for displaying information related to at least one television program, said system comprising:
an Internet connected host for transmitting a signal including the information related to the at least one television program; and
a remote control device comprising a receiver for receiving the signal including the information related to the at least one television program, processing circuitry for processing the received signal to obtain the information, and a display for displaying the information.

8. The system according to claim 7, further comprising an input interface for interacting with the displayed information.

9. The system according to claim 7, wherein the Internet connected host connects to a remote server via the Internet to receive the information related to the at least one television program.

10. A system for transmitting information related to at least one television program, said system comprising:
a remote central station for transmitting a signal including the information related to the at least one television program, wherein the signal is formatted to be received by a remote control device comprising a receiver for receiving the signal including the information related to the at least one television program, processing circuitry for processing the received signal to obtain the information related to the at least one television program, and a display for displaying the information.

11. The system according to claim 10, wherein the remote central station includes Internet connection means for connecting to the Internet and transmitting the signal via the Internet.
